(19) United States
(12) Patent Application Publication
(10) Pub. No.: US 2015/0381579 A1
(43) Pub. Date: Dec. 31, 2015

(54) METHOD AND SERVER FOR HANDLING OF PERSONAL INFORMATION

(71) Applicant: VIVALECT SOFTWARE AB, GOTEBORG (SE)

(72) Inventors: Philip Lundin, Goteborg (SE); Hani GLAIDOS, Uppsala (SE)

(21) Appl. No.: 14/705,075

(22) Filed: May 6, 2015

(30) Foreign Application Priority Data
Jun. 26, 2014 (EP) 14174089.4

(51) Int. Cl. H04L 29/06; G06F 17/30; H04L 29/08

(52) U.S. Cl. CPC H04L 63/0428; H04L 67/02; H04L 67/22; H04L 67/306; G06F 17/30864

(57) ABSTRACT

The present disclosure relates to a method for facilitating handling of personal information. In particular, the present disclosure relates to a computer implemented method for segmenting personal information into encrypted personal data an unencrypted non-personal data. The disclosure also relates to a method for profile aggregation as well as a corresponding server for profile aggregation.

Advantages with the disclosure include not having to disclose any personal data to a third party in case of third party user data analysis. In addition, as an active segmentation of the personal information into encrypted personal data and unencrypted non-personal data it is possible to apply generic and presently available data mining algorithms in regards to the unencrypted data.

### TECHNICAL FIELD

The present disclosure relates to a method for facilitating handling of personal information. In particular, the present disclosure relates to a computer implemented method for segmenting personal information into encrypted personal data and unencrypted non-personal data. The disclosure also relates to a method for profile aggregation as well as a corresponding server for profile aggregation.

### BACKGROUND OF THE INVENTION

Advertisements are a part of daily life and play an important role in relation to for example revenue generation for different Internet service providers, such as advertisement integrated within public websites. It is desirable to target such advertisements to the user visiting the website, and Internet service providers have found ways to selectively insert their advertisements based on a user's requests for information.

As an example, a user who has once visited a webpage and there requested information for example relating to “bicycles”, may be presented with advertisement relating to just bicycles when visiting the website a second time, completely independent what information the user request at the second visit. The use of “cookies” may allow such handling of user information.

The use of cookies provides only limited possibilities for storage of user information, and it may in some instances be desirable to include further information in relation to the user, for example personal information as to the user, including name, home/business address, email, etc. to thereby further craft what content to present. The provided information, typically stored as a user profile in a database connected to the website, is generally strictly connected to only one single website and not shared between different websites/domains/companies. Specifically, legal regulations, commitments, etc. made to the user as to the user's privacy makes it essentially impossible to share information between different domains/companies.

For the foregoing reasons, there is a need for a novel method configured for allowing safe and secure handing and sharing of user data comprised with a user profile, without violating legal regulations, commitments, etc. made to the user.

### SUMMARY

According to an aspect of the disclosure, the above is at least partly met by a computer-implemented method for segmented coding of personal profile data for a first user, the method comprising the steps of acquiring personal information about the first user via a first website, automatically dividing the personal information into a plurality of separate personal data portions, assigning characterizing identifiers for each of the plurality of separate personal data portion, tagging the characterizing identifiers for each of the plurality of separate personal data portions according to a predetermined scheme, wherein each of the plurality of separate personal data portions may be tagged as comprising one of personal or non-personal data relating to the first user, and automatically coding personal data portions tagged as comprising personal data using a predefined encryption method, wherein personal data portions tagged as comprising non-personal data remains unencrypted.

The present inventors have identified that it should be possible to make further use of personal data for a user for improving an understanding about the user, thus for example making a user experience in regards to a media presentation more appealable to the user. However, prior-art methods for improving the understanding about a user are generally limited to “single domain” situations, that is, due to legal regulations and/or commitments made to the user it is difficult and in some jurisdictions impossible to allow a third party to perform any form of data analysis in regards to the personal data. The present disclosure therefore introduces a computer based and automated process of segmenting personal information into personal and non-personal data, where the personal data is encrypted and the non-personal data is left unencrypted. For achieving such a functionality, a predefined and possibly self-learning scheme is utilized for determining if separate portions of the personal data should be “tagged” (i.e. determined) as one of personal or non-personal.

The automated process according to the disclosure allows for further data processing/analysis of the personal data, without having to release any data that would breach the trust of the user and/or possibly violating any legal requirements. Rather, the further data processing/analysis will typically only be allowed to be made in regards to the unencrypted personal data, thus for example not disclosing the real identity related to the unencrypted personal data.

As an example, in case a batch of personal information (e.g. a combination of strings together providing the portions of personal data) containing user name, email address, home address, age, gender, city, country, a plurality of different interests, combined browsing pattern, are provided as an input to the above method, a possible dynamic analysis of the content will be made, possibly irrespectively of the order of the elements/portions of the personal information. The analysis will follow a self learning and in some sense predetermined schedule for determining what portions of the personal information should be considered (tagged) as personal or non-personal.

It may be of high interest to perform a detailed analysis of the different portions of the personal data. When performing such an analysis, the different portions may be correlated to each other as well as with further, e.g. statistical, information. That is, some portions of the personal data may generally be bluntly considered as personal, however when a correlation with further statistical information is made, it may be understood that such information rather should be classified as non-personal. For example, in case the user is a male, 45 years old and living in a city, where the city (according to further statistical information) has a very small population, the combined knowledge of “male—45 years old” would be personal since it could be rather easy to find out the real identity of that specific user. However, with the same combination but in case of the user living in a city with a large population (or with a population being above a predetermined statistical threshold), the combined knowledge of “male—45 years old” would not make the user easily recognized and thus the information could be tagged as non-personal. Further more complex scenarios could be considered and are within the scope of the invention.

Based on the above discussion, the present disclosure provides advantages resulting in not having to disclose any personal data to a third party in case of third party user data analysis. In addition, as an active segmentation of the personal information into encrypted personal data and unencrypted non-personal data is made, it is possible to apply generic and presently available data mining algorithms in regards to the unencrypted data.

Conversely, there are methods available for data analysis (or at least arithmetic computation) for handling also encrypted data. One example of such a method is homomorphic encryption where arithmetic computation is made possible while the data is still kept encrypted. However, homomorphic encryption and computation is presently slow and demands massive computational resources, specifically as the computation time drastically increases with increased the security level.

Thus, by means of the present disclosure an high security level is possible while at the same time allowing for the use of generic data mining algorithms only demanding a fraction of the computational resources as needed in regards to e.g. homomorphic encryption. It should however be understood that it is possible to combine homomorphic encryption in regards to the encrypted personal data with generic data analysis in regards to the non-personal data.

In regards to the present disclosure, it is preferred to use for example a one-way encryption method in regards to the personal data, such as for example including a hash function. As such, a portion of personal data of arbitrary size that is encrypted using a hash function will typically generate a data string of fixed size. The fixed size data string representing the portion of personal data may then be used as an “identifier” for the portions of the personal information tagged as “personal data”. As an example, a batch of personal information as mentioned above may create distinct identifiers in regards to e.g. the name and email and home address that may be used as distinct parameters for the personal information and easily used as “pointers” when performing e.g. further analysis. This concept will be further discussed in relation to the detailed description of the present disclosure.

In a preferred embodiment, the method further comprises the steps of automatically entering the partly encrypted and partly unencrypted personal information for the first user within an intermediate database, and configuring the intermediate database for third party access to the personal information about the first user. As mentioned above, this configuration would only allow third party access to the combination of partly encrypted/unencrypted information without in fact revealing any information about the user considered and thereby tagged as personal.

Preferably, the method further comprises performing data analysis of at least the unencrypted personal data, and updating the intermediate database with the result of the data analysis, wherein the result is set to be related to the previously entered partly encrypted and partly unencrypted personal information for the first user within the intermediate database. Accordingly, a more thorough understanding may be provided in regards to the user based on further analysis performed in relation to the unencrypted personal information.

In preferred embodiment, the method additionally comprises the steps of automatically entering the partly encrypted and partly unencrypted personal information for the first user within an aggregation database, repeating the step of automatically entering partly encrypted and partly unencrypted personal information for the first user within an aggregation database, wherein the partly encrypted and partly unencrypted personal information for the first user is acquired via a second website, matching, within the aggregation database, a plurality of corresponding entries of the encrypted personal data for the first user, aggregating, based on the plurality of matching entries of personal data for the first user, the unencrypted non-personal data for the first user, resulting in the aggregated profile for the first user, and automatically entering the aggregated profile within the aggregation database. This suggested implementation will be further discussed below.

According to another aspect of the disclosure there is provided a computer-implemented method for creating an aggregated profile for a first user, the method comprising acquiring personal information about the first user via a first website, wherein the personal information comprises personal data and non-personal data relating to the first user, automatically coding the personal data using a predefined encryption method, wherein the non-personal data remains unencrypted, automatically entering the personal information, comprising the encrypted personal data and the unencrypted non-personal data, within an aggregation database. The method is repeated for at least personal information for the first user acquired via a second website and further includes matching, within the aggregation database, a plurality of corresponding entries of the encrypted personal data for the first user, aggregating, based on the plurality of matching entries of personal data for the first user, the unencrypted non-personal data for the first user, resulting in the aggregated profile for the first user, and automatically entering the aggregated profile within the aggregation database.

As discussed above, the encrypted data is preferably encrypted in such a manner that the encrypted personal data may be used as distinct identifiers for the total personal information. Thus, it will according to the present invention be possible to match distinct personal data identifiers acquired from different websites, possibly at different domains. In case a match is found, the unencrypted personal data may be aggregated for a specific user. As an example, in case the name is tagged as personal data and generates a distinct identifier for the user, it would be possible to form an aggregated user profile combining and possibly correlating the interests for the user. The resulting aggregated profile will thus give a more thorough understanding of the user. Also this concept will be further elaborated in relation to the detailed description of the present disclosure.

In an embodiment, the method further comprises receiving a profile query from a first organization relating to the first website, the query comprising an encrypted representation of personal data for the first user (encrypted using the same predefined encryption method), searching the aggregation database for an aggregated profile matching the encrypted representation of the personal data for the first user, and providing the aggregated profile to the first organization, wherein the aggregated profile comprises non-personal data received from at least the first and the second website.

In another embodiment, the predefined method for encrypting the personal data comprises applying a predefined hash function to the personal data. Furthermore, the matching of corresponding entries of the encrypted personal data comprises applying a string searching algorithm. Advantageously, the personal data comprises at least one entry of personally identifiable information for the first user. In an embodiment, the personal data comprises a plurality of separate but related entries of personally identifiable information for the first user

Preferably, the first and the second websites are located at different domains. In another embodiment, the non-personal data comprises at least information relating to the first user's Internet activity, at least a keyword representing an interest for the first user, or a non-distinguishing personal data for the first user. In a possible embodiment, content presented to the user at the first website is dependent on the aggregated profile.

According to another aspect of the disclosure there is provided a computer-implemented method for creating an aggregated profile for a first user, the method comprising receiving, from a first organization, personal information about the first user acquired by the first organization, wherein the personal information comprises personal data and non-personal data relating to the first user, the personal data has been encrypted using a predefined encryption method, and the non-personal data remains unencrypted, automatically entering the personal information, comprising the encrypted personal data and the unencrypted non-personal data, within an aggregation database. The above is repeated for at least personal information for the first user received from a second organization, wherein the second organization is different from the first organization, and further includes matching, within the aggregation database, a plurality of corresponding entries of the encrypted personal data for the first user, and aggregating, based on the plurality of matching entries of personal data for the first user, the unencrypted non-personal data for the first user, resulting in the aggregated profile for the first user. This aspect of the invention provides similar advantages as discussed above in relation to the previously discussed aspects of the disclosure.

In an embodiment, the method further comprises automatically applying a string searching algorithm, such as a Rabin-Karp algorithm, for matching the plurality of corresponding entries of the encrypted personal data for the first user.

Advantageously, the method further comprises automatically correlating the combined unencrypted non-personal data for the first user with group data for a group comprising a plurality of different users, the group data comprising non-personal data for the group, and automatically including, if a correlation if found between the non-personal data for the first user and for the group, an additional component to the aggregated profile based on the non-personal data for the group.

According to a further aspect of the disclosure, there is provided a user profiling server configured to create an aggregated profile for a first user, said server comprising a processor configured with a plurality of software modules, the modules including an aggregation database, an reception and storage module configured to receive personal information about the first user acquired by the first organization, wherein the personal information comprises personal data and non-personal data relating to the first user, the personal data has been encrypted using a predefined encryption method, and the non-personal data remains unencrypted, and automatically entering the personal information, comprising the encrypted personal data and the unencrypted non-personal data, within the aggregation database. The reception and storage module are further configured to receive and enter personal information for the first user from at least a second organization within the aggregation database, and the profiling server further including a profiling module configured to match, within the aggregation database, a plurality of corresponding entries of the encrypted personal data for the first user; and aggregate, based on the plurality of matching entries of personal data for the first user, the unencrypted non-personal data for the first user, resulting in the aggregated profile for the first user. Also this aspect of the invention provides similar advantages as discussed above in relation to the previously discussed aspects of the disclosure.

In an embodiment, the server further includes an advertisement selection module configured to select an advertisement corresponding to the aggregated profile. In another embodiment the profiling module evaluates the unencrypted non-personal data by comparing synonyms of keywords comprised with the non-personal data. Preferably, the user profiling server further includes a connection module configured to receive personal information from at least a first and a second domain.

Further features of, and advantages with, the present disclosure will become apparent when studying the appended claims and the following description. The skilled addressee realize that different features of the present disclosure may be combined to create embodiments other than those described in the following, without departing from the scope of the present disclosure.

### BRIEF DESCRIPTION OF THE DRAWINGS

The various aspects of the disclosure, including its particular features and advantages, will be readily understood from the following detailed description and the accompanying drawings, in which:

FIG. 1 conceptually illustrates a client-server environment where the present concept may be applied;

FIGS. 2a and 2b illustrate flow charts showing the method steps according to different aspects of the present disclosure;

FIG. 3 conceptualizes the segmentation and partially encryption of personal data, and

FIG. 4 conceptualizes the aggregation of a user profile based on personal information in a multi domain environment.

### DETAILED DESCRIPTION

The present disclosure will now be described more fully hereinafter with reference to the accompanying drawings, in which example embodiments of the disclosure are shown. This disclosure may, however, be embodied in many different forms and should not be construed as limited to the embodiments set forth herein; rather, these embodiments are provided for thoroughness and completeness, and fully convey the scope of the disclosure to the skilled addressee. Like reference characters refer to like elements throughout

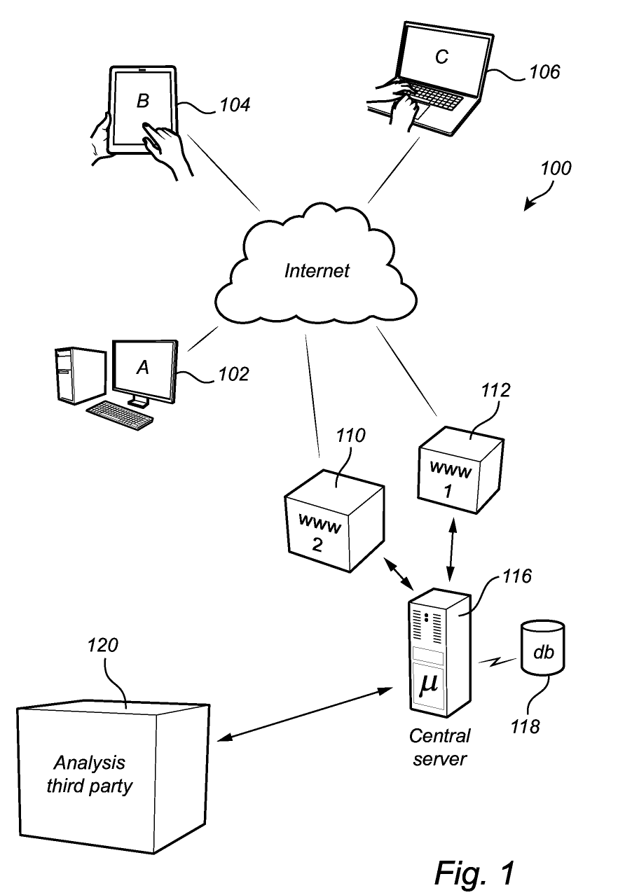

Referring now to the drawings and to FIG. 1 in particular, there is depicted, conceptually, a client-server environment 100 where the present concept may be applied. The client-server environment comprises a plurality of clients 102, 104, 106 controlled by different users A, B and C, respectively, all connected to the Internet 108. The clients 102, 104, 106 access multiple servers 110, 112 through the Internet 108, typically arranged as different domains (WWW_1, WWW_2). Once a specific user (e.g. user A will be used in the below description) is or has been connected to both servers 110, 112, the servers 110, 112 will create a user profile for the user A, typically based on information received from the user A and/or from information collected based on e.g. a browsing behavior of the user A.

The user profiles created by the respective servers 110, 112 may typically not be shared there between due to user commitments and/or legal regulations applied in relation to storage of user information. However, in accordance to the present disclosure, the servers 110, 112 may be in connection with a central server 116 configured to segment user information in such a manner that further information analysis may be applied without violating the above mentioned commitments/regulations. The central server 116 is typically connected to a database 118.

In addition, a third party server 120 may be in communication with the central server 116 and database 118 for performing the mentioned further analysis.

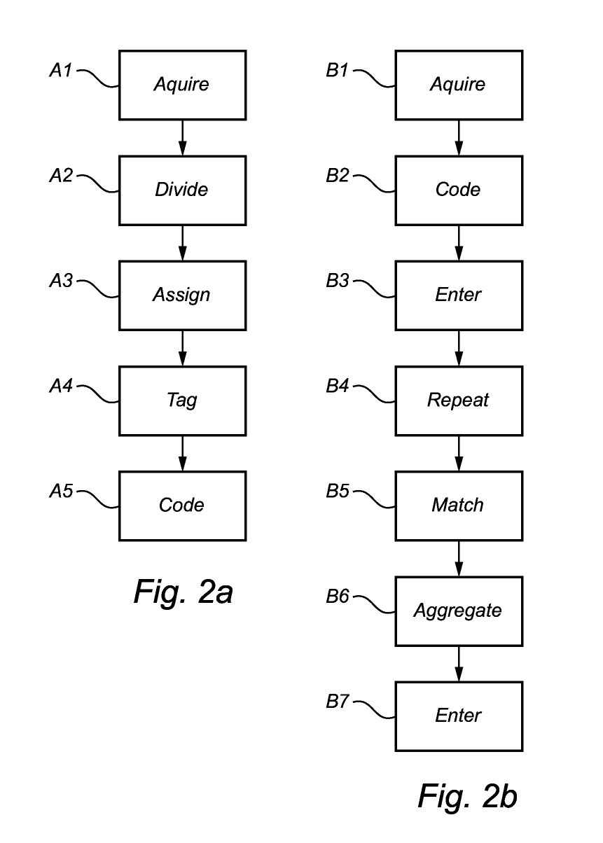

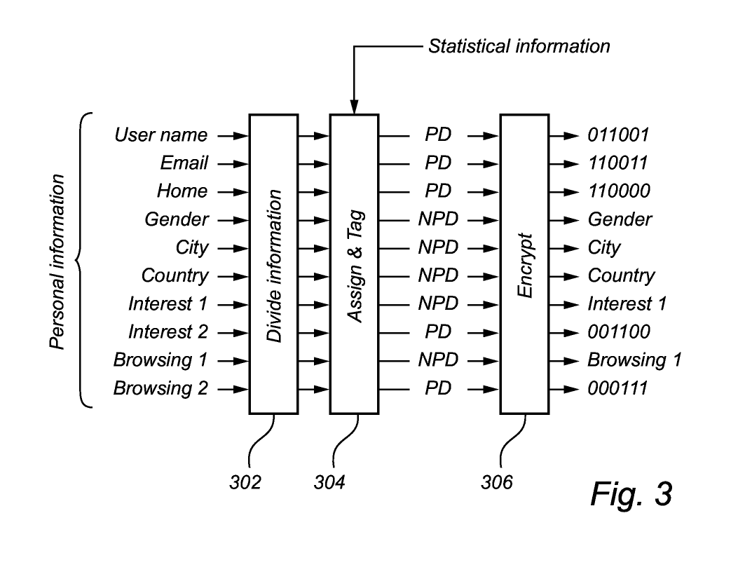

For achieving the above introduced segmentation of user information, further reference is made to FIGS. 2a and 3 in conjunction. In an embodiment of the disclosure, the user information (personal information) comprises a plurality of data portions providing a definition of the user A. The data portions may e.g. comprise information in regards to a user name, email, home address, gender, city, country and a plurality of interests and browsing patterns acquired, A1, received and/or otherwise collected through a website, such as a first website hosted by server 110. The central server 116, receiving the personal information from the server 110 divides, A2, the information into the mentioned data portions in a first computer module 302, forwards the plurality of data portions to a second computer module 304 where a predefined and possibly self-learning scheme is applied for assigning, A3, characterizing identifiers and for determining if the plurality of individual data portions should be tagged, A4, as personal data (PD) or non-personal data (NPD).

In the illustration provided in relation to FIG. 3, the user name, email, home address, some of the interests (Interest 1) and some of the browsing pattern (Browsing 2) are determined to be personal data (PD). The remaining plurality of data portions are considered to be non-personal data (NPD). The second computer module 304 may acquire e.g. statistical information for use in determining if the plurality of data portions should be considered (tagged) as personal or non-personal data. In addition, it may according to the present disclosure be possible to correlate some of the plurality of data portions with each other, possibly also taking info account the external statistical information. As such, considerations may be made resulting in that some data portions may be tagged as personal data rather than non-personal data, and vice versa.

It may be possible to use the concept of “Personally Identifiable Information” (PII) for determine is the data portions (taken separate or in combination) should be considered as personal or non-personal (i.e. personal information=PII). According to the definition of PII, PII is information that can be used on its own or with other information to identify, contact, or locate a single person, or to identify an individual in context. The concept of PII may according to the present disclosure be adapted based on the country of origin of the user, as different rules applies in regards to PII applies in different countries. The concept of PII may in accordance to the present disclosure be used alone in regards to the consideration if data portions should be personal or non-personal. However, in a typical embodiment of the present disclosure the concept of PII is used as a component in regards to the second computer module 304 where the individual data portions are tagged as personal or non-personal (PD/NPD).

A third computer module 306 then received the tagged (PD/NPD) plurality of portions of data and applies a predefined encryption scheme for coding, A5, the plurality of data portions tagged as being personal data (PD). In an embodiment of the present disclosure, an encryption scheme comprising a one-way encryption scheme is applied, such as using a hash function. In using a hash function, an arbitrary string of information will be mapped to a fixed length e.g. numeric (or alpha numeric) string of data representing the specific portion of personal data. In the embodiment shown in FIG. 3, the data portions decided to comprise personal data are mapped (encrypted) to six digits data strings. Any length may of course be applied; the illustration provided in FIG. 3 is just for illustrative purposes.

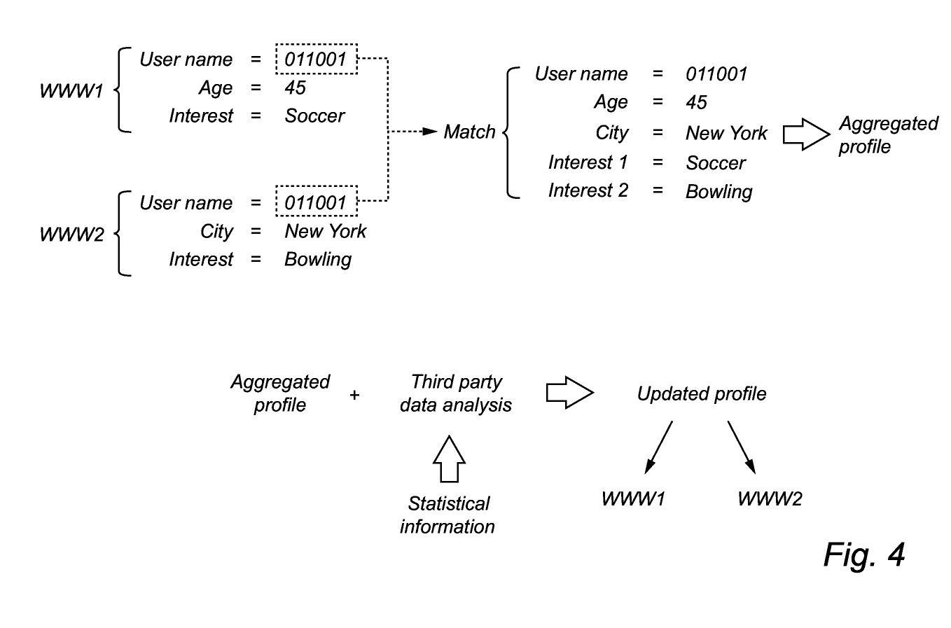

Turning now to FIGS. 2b and 4 in conjunction, in a similar manner as discussed in relation to FIG. 2a, user data is acquired, B1. The data may in one embodiment be processed as discussed in relation to FIGS. 2a and 3 (i.e. coded, B2, using the predefined encryption scheme and entered, B3 into the database 118), or the process may be performed as integrated with the process of FIG. 2b.

In any case, the process is of acquiring, B1, coding, B2, and entering, B3, of personal data is repeated, B4, for personal information acquired in a multi domain environment, e.g. using multiple websites individually hosted by servers 110, 112. Once the partly encrypted and partly unencrypted data received from the servers 110, 112 is stored in the database 118, the central server 116 will apply a matching algorithm, such as for example a Rabin-Karp algorithm for determine if e.g. any encrypted data portions relating to a user name is stored in the database 118.

In the present illustration, the user A accessing servers 110, 112 has entered a user name that once encrypted according to the above disclosed procedure will generate a six digit data string, exemplified as “011001”. The central server 116 matches the data portion received from the server 110 with the data portion received from the server 112. As a match is found, it will be possible to aggregate the unencrypted data portions provided from the respective servers 110, 112 and stored in the database 118. In the present illustration of FIG. 4, the age, some interests and the city of the user “011001” are combined into an “aggregation user profile”.

The aggregation profile may in turn be provided to a third party server 120, still having no access to any information considered (tagged) as personal data, for allowing further data analysis and/or data mining, possibly using generic matching algorithms correlating different e.g. interests with age and city/country for suggesting further information that could be of interest for the user.

The aggregated user profile may in turn be combined with the information provided from the third party server 120 for forming an “updated profile”. The updated profile may then be provided back to the servers 110, 112 to be used by the hosted websites (WWW_1, WWW_2) for creating an improved user experience for the user.

In summary, the present disclosure relates to a computer-implemented method for segmented coding of personal profile data for a first user, the method comprising the steps of acquiring personal information about the first user via a first website automatically dividing the personal information into a plurality of separate personal data portions, assigning characterizing identifiers for each of the plurality of separate personal data portion, tagging the characterizing identifiers for each of the plurality of separate personal data portions according to a predetermined scheme, wherein each of the plurality of separate personal data portions may be tagged as comprising one of personal or non-personal data relating to the first user, and automatically coding personal data portions tagged as comprising personal data using a predefined encryption method, wherein personal data portions tagged as comprising non-personal data remains unencrypted.

Advantages with the disclosure include not having to disclose any personal data to a third party in case of third party user data analysis. In addition, as an active segmentation of the personal information into encrypted personal data and unencrypted non-personal data it is possible to apply generic and presently available data mining algorithms in regards to the unencrypted data.

The present disclosure contemplates methods and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps. Additionally, even though the invention has been described with reference to specific exemplifying embodiments thereof, many different alterations, modifications and the like will become apparent for those skilled in the art. Variations to the disclosed embodiments can be understood and effected by the skilled addressee in practicing the claimed invention, from a study of the drawings, the disclosure, and the appended claims. Furthermore, in the claims, the word “comprising” does not exclude other elements or steps, and the indefinite article “a” or “an” does not exclude a plurality.

1. A computer-implemented method for segmented coding of personal profile data for a first user, the method comprising the steps of:
acquiring personal information about the first user via a first website;
automatically dividing the personal information into a plurality of separate personal data portions;
assigning characterizing identifiers for each of the plurality of separate personal data portion;
tagging the characterizing identifiers for each of the plurality of separate personal data portions according to a predetermined scheme, wherein each of the plurality of separate personal data portions may be tagged as comprising one of personal or non-personal data relating to the first user; and
automatically coding personal data portions tagged as comprising personal data using a predefined encryption method, wherein personal data portions tagged as comprising non-personal data remains unencrypted.

2. The method according to claim 1, further comprising the steps of:
automatically entering the partly encrypted and partly unencrypted personal information for the first user within an intermediate database; and
configuring the intermediate database for third party access to the personal information about the first user.

3. The method according to claim 1, further comprising the steps of:
performing data analysis of at least the unencrypted personal data; and
updating the intermediate database with the result of the data analysis, wherein the result is set to be related to the previously entered partly encrypted and partly unencrypted personal information for the first user within the intermediate database.

4. The method according to claim 1, further comprising the steps of:
automatically entering the partly encrypted and partly unencrypted personal information for the first user within an aggregation database;
repeating the step of automatically entering partly encrypted and partly unencrypted personal information for the first user within an aggregation database, wherein the partly encrypted and partly unencrypted personal information for the first user is acquired via a second website;
matching, within the aggregation database, a plurality of corresponding entries of the encrypted personal data for the first user;
aggregating, based on the plurality of matching entries of personal data for the first user, the unencrypted non-personal data for the first user, resulting in the aggregated profile for the first user; and
automatically entering the aggregated profile within the aggregation database.

5. A computer-implemented method for creating an aggregated profile for a first user, the method comprising the steps of:
acquiring personal information about the first user via a first website, wherein the personal information comprises personal data and non-personal data relating to the first user;
automatically coding the personal data using a predefined encryption method, wherein the non-personal data remains unencrypted;
automatically entering the personal information, comprising the encrypted personal data and the unencrypted non-personal data, within an aggregation database;
repeating the steps of acquiring, coding and entering of personal information for the first user acquired via a second website;
matching, within the aggregation database, a plurality of corresponding entries of the encrypted personal data for the first user;
aggregating, based on the plurality of matching entries of personal data for the first user, the unencrypted non-personal data for the first user, resulting in the aggregated profile for the first user; and
automatically entering the aggregated profile within the aggregation database.

6. The method according to claim 5, further comprising:
receiving a profile query from a first organization relating to the first website, the query comprising an encrypted representation of personal data for the first user;
searching the aggregation database for an aggregated profile matching the encrypted representation of the personal data for the first user; and
providing the aggregated profile to the first organization, wherein the aggregated profile comprises non-personal data received from at least the first and the second website.

7. The method according to claim 5, wherein the predefined method for encrypting the personal data comprises applying a predefined hash function to the personal data.

8. The method according to claim 5, wherein the matching of corresponding entries of the encrypted personal data comprises applying a string searching algorithm.

9. The method according to claim 5, wherein the personal data comprises at least one entry of personally identifiable information for the first user.

10. The method according to claim 5, wherein the personal data comprises a plurality of separate but related entries of personally identifiable information for the first user.

11. The method according to claim 5, wherein the first and the second websites are located at different domains.

12. The method according to claim 5, wherein the non-personal data comprises at least information relating to the first user's Internet activity, at least a keyword representing an interest for the first user, or a non-distinguishing personal data for the first user.

13. The method according to claim 6, wherein content presented to the user at the first website is dependent on the aggregated profile.

14. A user profiling server configured to create an aggregated profile for a first user, said server comprising a processor configured with a plurality of software modules, the modules including:
an aggregation database;
an reception and storage module configured to:
receive personal information about the first user acquired by the first organization, wherein the personal information comprises personal data and non-personal data relating to the first user, the personal data has been encrypted using a predefined encryption method, and the non-personal data remains unencrypted;
automatically entering the personal information, comprising the encrypted personal data and the unencrypted non-personal data, within the aggregation database;
wherein the reception and storage module is further configured to receive and enter personal information for the first user from at least a second organization within the aggregation database, and the profiling server further including:
a profiling module configured to
match, within the aggregation database, a plurality of corresponding entries of the encrypted personal data for the first user; and
aggregate, based on the plurality of matching entries of personal data for the first user, the unencrypted non-personal data for the first user, resulting in the aggregated profile for the first user.

15. The user profiling server according to claim 14, wherein the second organization is different from the first organization.

16. The user profiling server according to claim 14, further including:
an advertisement selection module configured to select an advertisement corresponding to the aggregated profile.

17. The user profiling server according to claim 14, wherein the profiling module evaluates the unencrypted non-personal data by comparing synonyms of keywords comprised with the non-personal data.

18. The user profiling server according to claim 14, further including:
a connection module configured to receive personal information from at least a first and a second domain.
